(19) United States
(12) Patent Application Publication
(10) Pub. No.: US 2017/0334699 A1
(43) Pub. Date: Nov. 23, 2017

(54) CHAMBER LID TOOL

(71) Applicant: Mohammad ABDOLI-ERAMAKI, Toronto, Ontario (CA)

(72) Inventor: Mohammad ABDOLI-ERAMAKI, Toronto, Ontario (CA)

(21) Appl. No.: 15/535,777

(22) PCT Filed: Dec. 14, 2015
(86) PCT No.: PCT/CA2015/051322

§ 371 Date: Jun. 14, 2017

Related U.S. Application Data
(60) Provisional application No. 62/091,771, filed on Dec. 15, 2014.

(51) Int. Cl. B66F 19/00; B66F 15/00

(52) U.S. Cl. CPC B66F 19/005; B66F 15/00

(57) ABSTRACT

A manhole cover tool useful in unsealing and moving a manhole cover over a predetermined distance along a surface, including: i) A handle end; accommodating an operator; ii) A fulcrum end distant the handle end; suitable for engagement and stabilizing the tool on the surface; iii) A rod of a predetermined length for connecting the handle end t o the fulcrum end; iv) A manhole cover engagement rod of a predetermined length having a first end and a second end; the first end connected to the rod, and said second end being a manhole cover engagement tool.

### FIELD OF THE DISCLOSURE

A chamber lid tool for removing, moving and replacing a chamber lid, is provided which reduces the need for heavy pulling and/or lifting of a chamber lid when cracking the seal of the chamber lid and removing the lid by an operator to allow access to underground electrical chambers. The chamber lid tool uses the principle of a first class counter lever.

### BACKGROUND

Across many industries, services sector workers are most prone to experiencing high impact injuries. Amongst them, electrical powerline workers are often subject to physically demanding work, typically involving exerting high forces in awkward postures. Often times these workers handle routine tasks in servicing underground power lines ranging from removing 300 lb manhole covers to bending power cables 2-3 inch in diameter in tight working spaces. These working conditions are often exacerbated by emergencies requiring performance of tasks in an urgent manner in order to reduce the impact of down time for services delivered to customers. Working under such conditions may result in unnecessary strain and may increase the chance of injury due to improper handling of tasks.

Lifting and removal of underground chamber lids has been identified as a physically challenging work task. Tools and devices available in the market purportedly address this physically challenging work task, but are not popular options for utility workers given the tools and devices are cumbersome to handle and time consuming to use. Ultimately, a simple pole with a hook remains the preferred choice for utility workers due to ease of storage in a service vehicle and effectiveness in performing the needed task.
The use of the hooked pole however, still requires lifting activities involving high joint moments of the worker to remove the heavy chamber lids increasing the risk of personal injury.

U.S. Pat. No. 4,512,554 discusses a levering tool for lifting up a manhole cover. The levering tool disclosed therein requires the operator to pull the handle engaging the arm shoulder and back muscles in an unstable position risking injury to the operator. Similarly, U.S. Patent Application Publication 20120027559 discusses a levering tool for lifting up a manhole cover. The levering tool disclosed therein also requires the operator to pull the handle while keeping the forearms substantially horizontal and the back substantially vertical to the ground. The pulling action again places the operator in a position of potential muscle or joint strain and/or injury.

U.S. Pat. No. 4,978,103 discusses a levering tool for lifting and moving a manhole cover. The manhole cover must first be unsealed by a separate tool and then the levering tool is engaged with the manhole cover and pulled backwards and rolled to another position by the constant pulling of the manhole cover with its weight supported on the levering tool and requiring control of the weight of the manhole cover by the operator at all times.

There is a need for a manhole cover tool which may crack or unseal the manhole cover and move the manhole cover with a single tool. There is also a need for a manhole cover tool which does not require pulling both the tool and manhole cover simultaneously under the weight of the manhole cover. There is also a need for a manhole cover tool with improved ergonomics for the operator during use, reducing the risk of injury. There is also a need for a manhole cover tool that is readily easy to handle and to be accommodating in storage spaces of trucks typically used by operators.

When used herein, the term manhole cover encompasses chamber lid and the like.

### SUMMARY

According to one aspect, there is provided a manhole cover tool useful in unsealing and moving a manhole cover over a predetermined distance along a surface, comprising:
i) A handle end; preferably a handle accommodating at least one hand of an operator, more preferably accommodating two hands of an operator;
ii) A fulcrum end distant said handle end; preferably an elongated arcuate ski shape with the bottom of said elongated arcuate ski shape suitable for engagement and stabilizing said tool on said surface; preferably further for assisting the operator to orient said tool with said chamber lid to allow for optimal use of said tool,
iii) A rod of a predetermined length for connecting said handle end to said fulcrum end;

iv) A manhole cover engagement rod of a predetermined length having a first end and a second end; said first end connected to said rod, preferably distant said handle end, and said second end being a manhole cover engagement tool, preferably a hook, or the like; preferably said engagement rod is flexible.
Wherein when said manhole cover tool is in a resting position, said handle end is proximate waist level of said operator, and said handle end and fulcrum end form an angle with said surface such that the operator is in a neutral standing position; preferably said angle is substantially a 45 degree angle with said surface; more preferably, said angle is one which brings said handle of said tool (at rest) proximate waist level of said operator.
Wherein when a line drawn from said handle end to said fulcrum end and from said fulcrum end to said first end of said engagement rod and from said first end of said engagement rod to said handle end, form a triangle.

According to another aspect, when said manhole cover tool is in use and said manhole cover engagement tool is engaged with and under the load of said manhole cover, an operator pushing said handle end down towards said surface results in said manhole cover to move towards the fulcrum end of said manhole cover tool a first predetermined distance. When said manhole cover tool is in use and said manhole cover engagement tool is engaged with and not under the load of said manhole cover, an operator pulling said handle, preferably without the weight of the manhole cover but only the weight of said tool, causes said fulcrum end to move along said surface away from said manhole cover to a second predetermined distance allowing the operator to move the manhole cover along said surface by pushing down on said handle causing the tool to drag the manhole cover along the surface.

According to another aspect, the manhole cover tool is of a height that facilitates the operator to push down on the handle by:
1. maintaining the arms substantially vertical with said surface; and
2. bend at the waist while maintaining an ergonomic stance and avoiding pulling the weight of the manhole cover; or
3. bend at the knees while maintaining an ergonomic stance and avoiding pulling the weight of the manhole cover; and
4. combinations thereof.

For example, for an operator of about 1.8 metres height, the tool would preferably be about 0.75 metres tall when said tool is in the resting position. The height of said tool may vary depending on the arm and leg length of the operator, as well as the overall height of the operator

According to another aspect, the manhole cover tool is adjustable in length, preferably to allow for height variation of the operator. In one embodiment, the tool may be adjusted in height by adjusting the angle the tool makes with the surface by raising or lowering the handle as well as adjusting the distance the fulcrum is from the chamber lid. In another embodiment, the connecting rod may be telescopic in nature to allow for adjustment of length and height of the tool.
In yet another embodiment, said manhole cover tool is made of a lightweight strong material, preferably aluminum, light formed steel, fiberglass, polypropylene, and combinations thereof. In one embodiment, said engagement rod is flexible, preferably a chain or steel cable, or the like. In another embodiment, said engagement rod runs along a portion of said connecting rod. Preferably said connecting rod further comprises an engagement rod channel for receiving said engagement rod and assisting in maintaining alignment of said engagement rod with said connecting rod when said tool is in use.

In another embodiment one of said connecting rod and/or engagement rod channel is substantially arcuate, half a tear drop or “D” shape with one end of the arc or “D” being proximate the handle end and the other end of the arc or “D” being proximate the fulcrum end. In another embodiment said fulcrum end, handle end and first end of said engagement rod, when connected, form a triangle. Preferably the line joining the fulcrum end and handle end forms a base of the triangle, and the first end of said engagement rod forms an apex of the triangle. More preferably, the distance from the base to the apex of the triangle is greater than the radius of the manhole cover to be engaged, more preferably at least twice the radius of the manhole cover to be engaged.

In another embodiment, said manhole cover tool is substantially triangular in shape.

In another embodiment, said engagement rod channel comprises a plurality of engagement rod connectors along said length to allow for the adjustment of the angle of said engagement rod to said connecting rod.

In another embodiment, said connecting rod comprises a plurality of engagement rod connectors along said length to allow for the adjustment of the angle of said engagement rod to said connecting rod.

In another embodiment, said manhole cover engagement tool comprises a hook having a hook end and a hook handle end, said hook end and hook handle end connected to each other via a connector. Said hook handle end weighing more than said hook end, such that when said hook is engaged with a manhole cover, said hook end is urged to remain engaged with said manhole cover until the operator disengages said hook from said manhole cover.
In another embodiment, there is provided a hook having a handle end and a hook end distant said handle end, said hook end connected to said handle end via a connector, preferably an elongated connector, wherein said handle end is heavier than said hook end.

In another embodiment, said hook when not in use is releasably fastened to said tool, preferably releasably fastened to at least one of said connecting rod or engagement rod, more preferably said hook is magnetically fastenable to at least one of said connecting rod or engagement rod, or both.

### BRIEF DESCRIPTION OF THE FIGURES

FIG. 1 is a side view of the manhole cover tool in the resting position

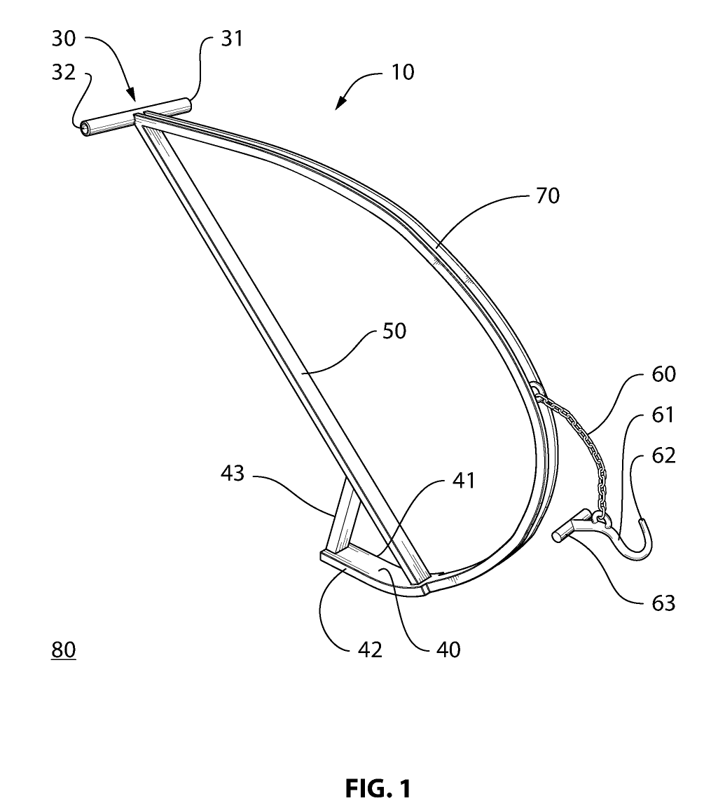

FIG. 2 is a perspective view of the manhole cover tool in the resting position

FIG. 3 is a side view of the manhole cover tool engaged with a manhole cover in the resting position

FIG. 4 is a side view of the manhole cover tool engaged with a manhole cover and cracking the seal of the cover

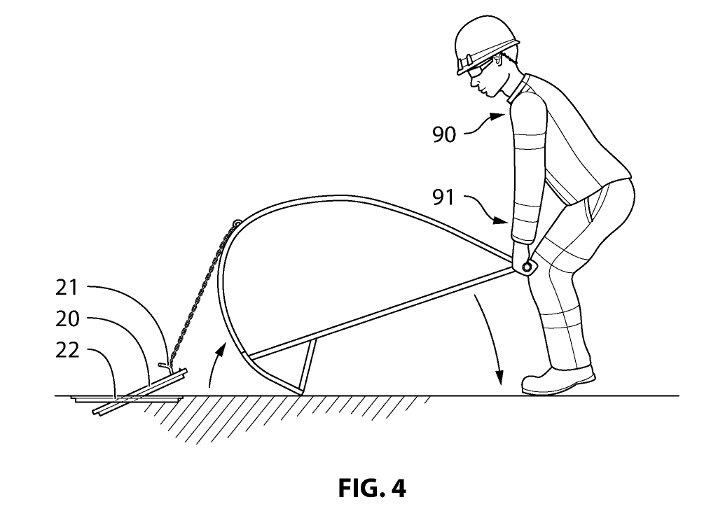

FIG. 5 is a side view of the manhole cover tool engaged with a manhole cover and dragging the cover along the surface

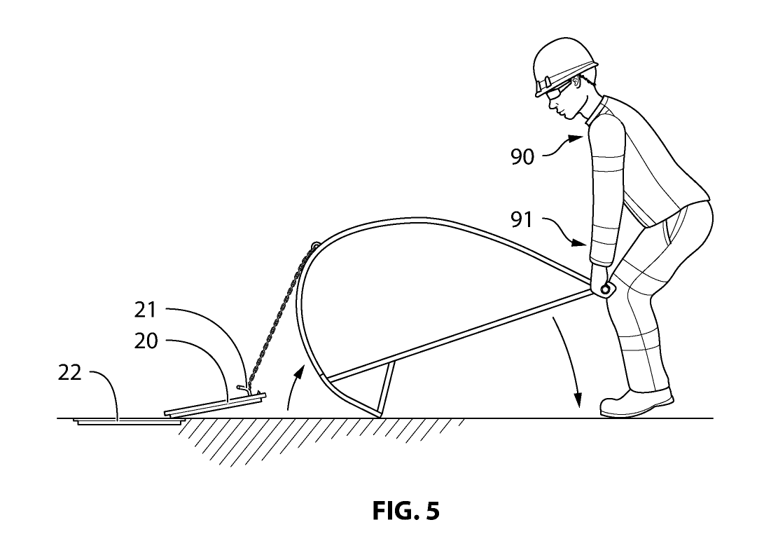

FIG. 6 is a side view of a manhole cover tool engaged with a manhole cover and the manhole cover dragged off the manhole

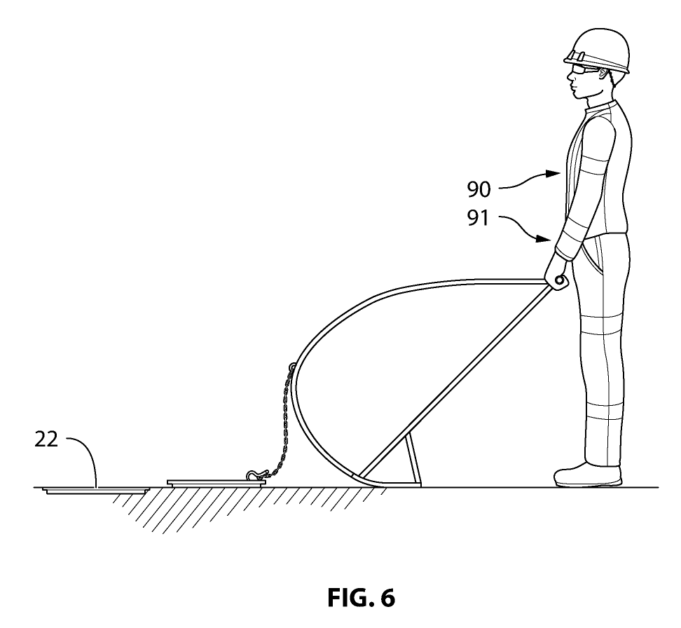

FIG. 7 is a side view of the manhole cover tool (at rest) engaged with a manhole cover showing the manhole cover engagement tool remaining engaged with said manhole cover until the operator disengages same

FIG. 8 is a perspective view of the manhole cover tool (at rest) of another preferred embodiment

FIG. 9 is a perspective view of the manhole cover tool of FIG. 8 with the connecting rod with handle in an extended position

FIG. 10 is a perspective view of the manhole cover tool of FIG. 9 with an extendable connector

FIG. 11 is a perspective view of the manhole cover tool of FIG. 10 with a fixed extended connector

### DETAILED DESCRIPTION

Referring now to the Figures, there is provided a preferred embodiment of a manhole cover tool 10 and a manhole cover 20. The manhole cover tool 10 has a handle 30 and a fulcrum 40 connected to each other by a connecting rod 50. The tool 10 further includes a manhole engagement rod 60 connected to an engagement rod channel 70 of arcuate or “D” shape. The radius formed between the connecting rod 50 and the engagement rod channel 70, in one instance, is greater than the radius of the manhole cover 20. This provides a mechanical advantage when moving said manhole cover 20. When the tool 10 is at rest, the connecting rod 50 forms a 45 degree angle with the surface 80 or the ground. This angle may be any angle which maintains the handle 30 proximate waist level of the operator 90, when said tool is at rest. The handle 30, in this instance, extends along the engagement rod channel 70 and beyond the connecting rod 50 and is made up of a left handle portion 31 and a right handle portion 32, each handle portion being substantially normal to and equidistant from said rod channel 70. Although not shown, the handle portions 31 and 32 may further include grip material to assist the operator in gripping the tool.

The fulcrum 40 is essentially ski shaped and is an extension of the engagement rod channel 70, extending beyond the fulcrum end 40 of the connecting rod 50. The fulcrum has a left ski portion 41 and a right ski portion 42 extending equidistant from said rod channel 70 and connecting rod 50, allowing for the lateral stabilization of the tool 10 when being used by an operator 90. The centre of the fulcrum 40 is at the terminus of the connecting rod 50 fulcrum end. Optional brace 43 further rigidifies fulcrum 40 with connecting rod 50, and in particular, when the tool 10 is in use. The engagement rod 60 is a steel chain connected at one end to the rod channel 70 and the other end having a hook 61 for engagement with an aperture 21 of the manhole cover 20.

In use, the operator 90 moves the tool 10 proximate the manhole cover and engages the hook 61 to an aperture 21 of the manhole cover 20. The operator 90 positions the tool 10 in the direction of choice to move the manhole cover 20, and pushes the handle 30 towards the surface 80 causing the tool to rotate along the ski portions 41 and 42 of the fulcrum 40, which in turn cracks the seal of the manhole cover. At this point, when the operator pulls the tool 10 away from the manhole cover 20 by dragging the fulcrum 40 along the surface 80, the operator 90 only experiences the weight of the tool 10 and not the weight of the manhole cover 20, and sets the tool 10 to its resting position where it forms a 45 degree angle with the surface 80. The operator pushes down on the handle 30 keeping the arms 91 substantially vertical to the surface 90 and back substantially straight while bending at the waist causing the tool 10 to pivot on the fulcrum 40 and in turn causing the engagement rod 60 to pull the manhole cover 20 and be dragged along the surface 80. In another embodiment, when pushing down on the handle 30, the operator 90 may also maintain the back substantially normal to the surface 80 while bending at the knees. The operator 90 continues these steps until the desired location for the manhole cover 20 is reached.

When the operator 90 wants to return the manhole cover 20 to its original position or to the manhole 22, the same actions are repeated as above except the direction will be towards the manhole 22 and the tool 10 is placed on the surface 80 proximate the side of the manhole 22 distant the manhole cover 20 (i.e. the open manhole 20 is between the tool 10 and the manhole cover 20).

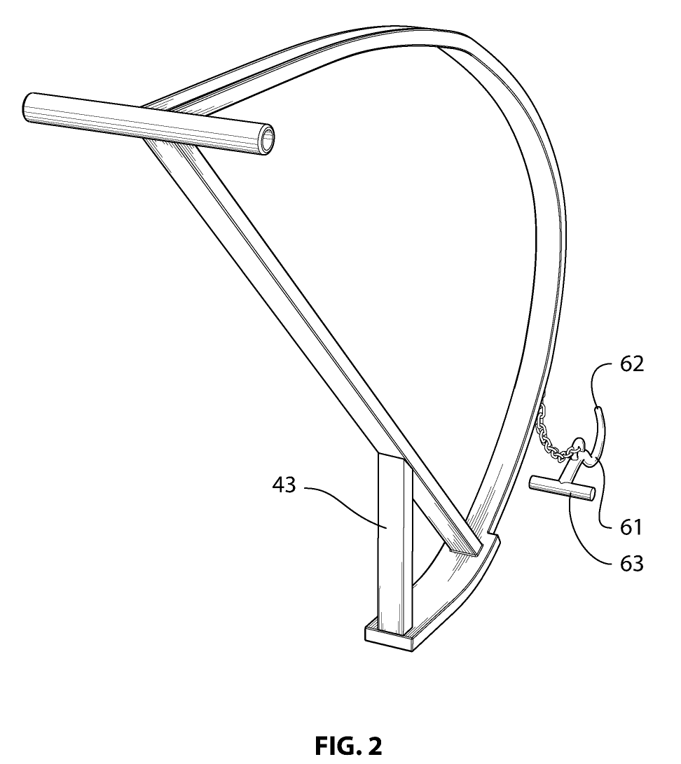

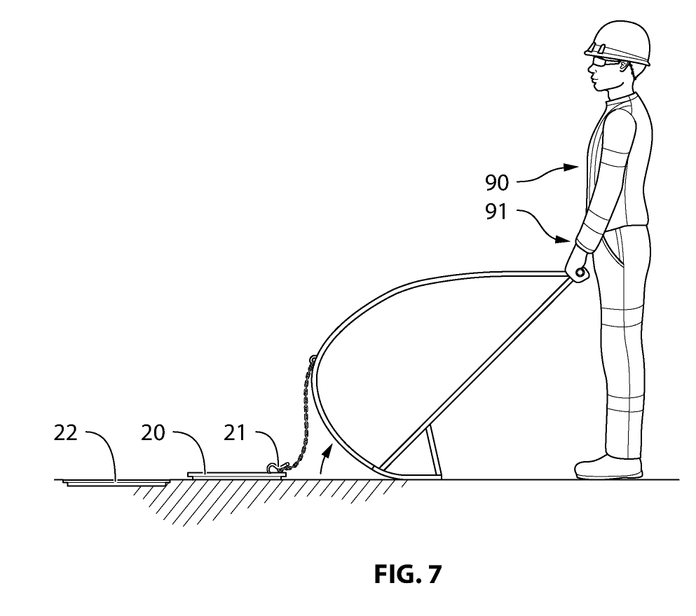

As best seen in FIGS. 2 and 7, in one embodiment, the hook 61 is constructed such that the hook end 62 is lighter that the hook handle end 63. This configuration allows the hook 61 to remain engaged with the manhole cover 20, when there is no tension between the hook 61 and the engagement rod 60, until the operator disengages the hook 61 from the cover 20 via the handle 63. In yet another embodiment, the engagement rod 60 is further connected to the hook 61 such that when there is tension between the hook 61 and engagement rod 60, the hook 61 is urged to remain engaged with the cover 20 when the operator 90 is moving the handle 30 downwards towards the surface 80. The configuration of the present hook 61 reduces the likelihood of injury to the operator 90 due to the hook 61 coming away from the cover 20 while in operation.

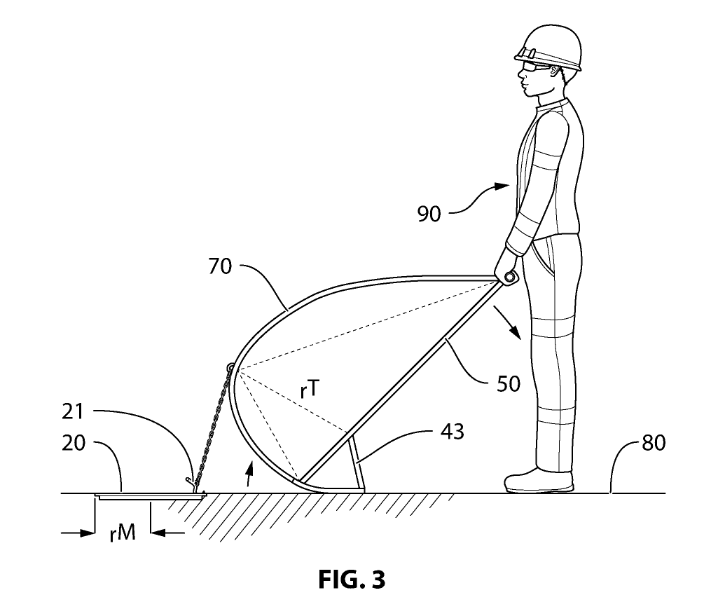

As best seen in FIG. 3, the fulcrum end 40, the handle 30 and the first end of the engagement rod 60, when connected to each other with a line, form a triangle. Also, in one embodiment, the distance rT is greater than the distance rM, preferably rT is at least twice rM

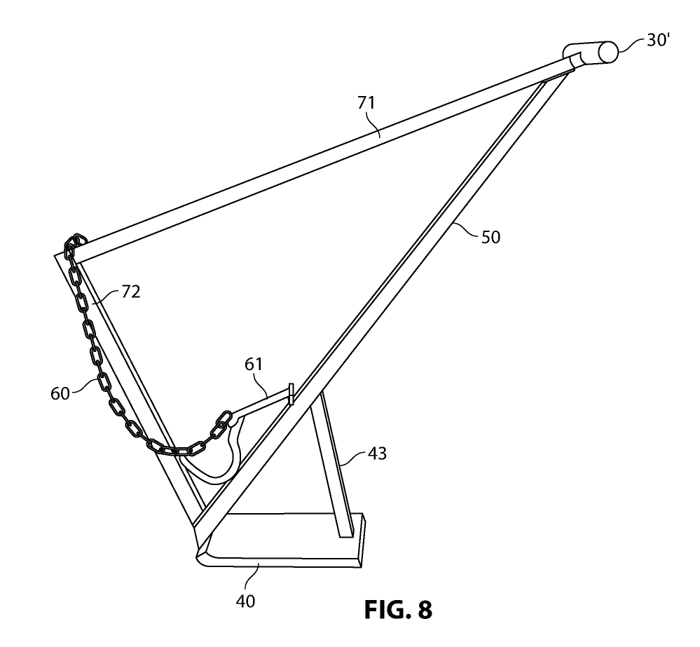

As best seen in FIG. 8, in this embodiment, the tool 10 is substantially triangular in shape (as opposed to the “D” shaped discussed above) with the handle engagement rod 71 connected directly to the connecting rod 50 at the handle end 30, and the handle engagement rod 71 connected to the connecting rod 50 via a connector 72 proximate the fulcrum end 40, such that the handle engagement rod 71, connecting rod 50 and connector 72 form a triangle. In this instance, the first end of the engagement rod 60 is connected at the joint formed by the handle engagement rod 71 and connector 72.

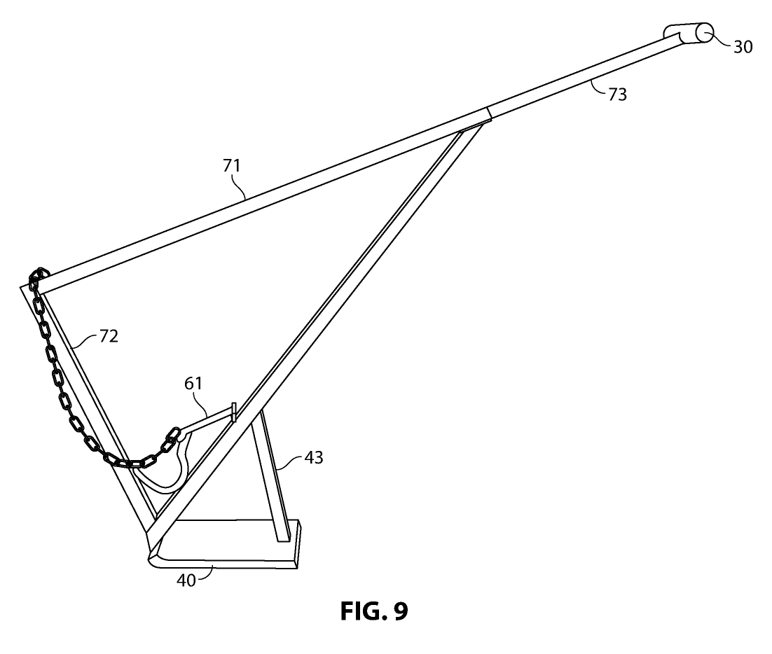

As best seen in FIG. 9, the handle 30 is extended via extender 73 in said handle engagement rod 71. In this instance, extender 73 fits in said handle engagement rod 71 allowing for the extension of the length of the handle engagement rod 71 facilitating users of various heights. Although not depicted, the extender 73 could fit in the engagement rod 60.

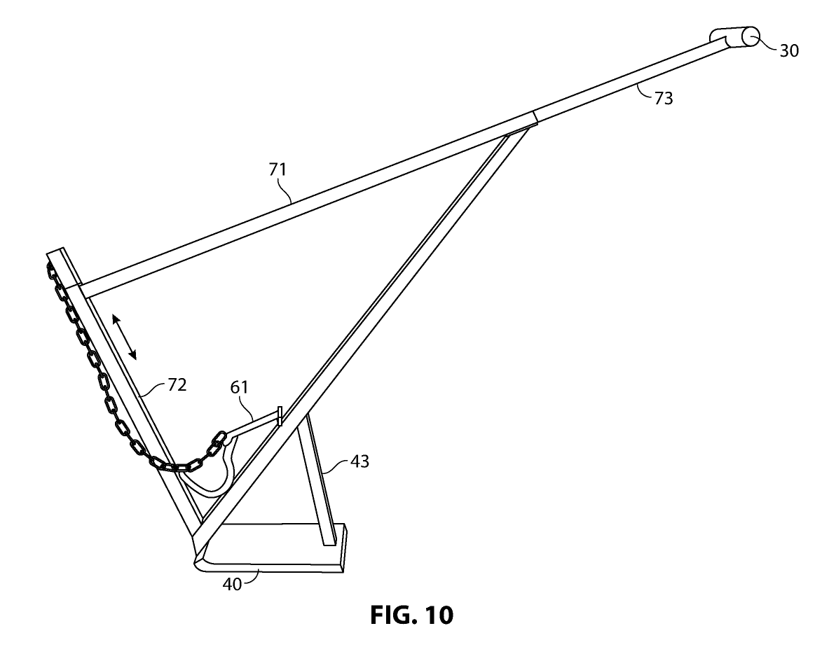

As best seen in FIG. 10, in this embodiment, the connector 72 is extended beyond the end of the handle engagement rod 71 allowing for accommodating longer engagement rods 60, in this instance a steel chain and for manhole covers of significant weight and size. The connector 72 may be fixed at the extended length or may be extendable via a telescopic manner for example such as that seen with the handle engagement rod 71. When extendable, a locking mechanism is preferred to lock the connector at the desired position when in use.

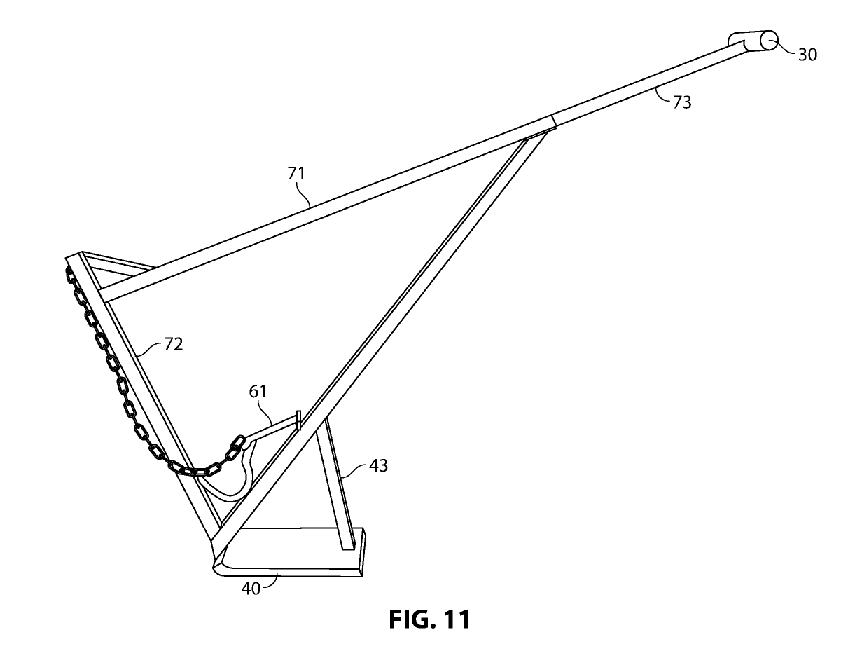

As best seen in FIG. 11, when the connector 72 length is fixed and is extended beyond the end of the handle engagement rod 71, the tool may further comprise and corner brace 74 to reinforce the strength of the connector 72 when extended beyond the end of the handle engagement rod 71.

The hook 61 is releasably attachable to said tool 10 via a magnetic area on at least one of said engagement rod 71, connecting rod 50, connector 72 or a combination thereof.

### EXAMPLES

The following are examples of the forces applied to the joints of the operator when using the tool as described herein and the tools of the prior art.

### Example 1

### Comparison of Moments Between Prior Art Tools and Present Tool

Initial comparison of the present tool and prior art tools was performed using 3DSSPP (3D static strength prediction program). This program estimates joint loading based on body position and forces applied. 3DSSPP combines force data with the posture and predicts the percent of the population who have the strength to do the job. In biomechanics research, increased joint moments often indicate increased risk of injury due to increased strain on the musculoskeletal system.
A comparison of the present tool with other available tools with respect to initial analysis with 3DSSPP and ergonomic and biomechanic factors is provided below. All moment data is given for the saggital plane (i.e. flexion/extension of the spine) as this is the plane where most movement occurs during the lid lift.

The tool currently used by most of hydro electronic services for removal of chamber lids is the pickaxe. Initial examination of the use of the pickaxe with a force meter indicates a requirement of 130-220 lbs of lifting force when using the pickaxe to lift a chamber lid. As shown in the graph below, this force results in a moment production in the spine of approximately 400N*m at L5/S1 and 360N*m at L4/L5. The moment produced at the shoulder is approximately 30N*m. Moments produced when using the pickaxe are much higher than moments produced using the present tool, which are approximately 20N* for both L5/S1 and L4/L5, and approximately 15N*m for the shoulder. In addition to decreased moments when using the present tool, the present tool allows the operator to push in a downwardly direction, recruiting the core muscles and allowing use of their body weight to apply the force, rather than using the back extensor muscles, as is done with the pickaxe.

Another prior art tool includes the tools found in U.S. Pat. No. 4,512,554 and U.S. patent publication 20120027559. Both of these prior art tools include a straight bar between the fulcrum and the handle as well as the handle orientation being horizontal. The straight bar of these prior art tools forces the operator to pull backwards using the shoulder and back extensor muscles, causing the pectoral muscles to contract and form a tight angle between the pectoral muscles and the arm muscles, along with the upper back muscles causing significant strain, wherein the muscle strain increases as the vertical handle gets closer to the operator. The present tool allows the operator to push down using the body core and body weight for assistance during operation. As shown in the graph below, the prior art tool of U.S. Pat. No. 4,512,554 and U.S. 20120027559 (T-lift) produces larger moments at L4/L5 (315N*m for T-lift; 20N*m for present tool) and L5/S1 (360N*m for T-lift, 20N*m for present tool). Large production of force by the back extensor muscles (as is the case for the T-lift and pickaxe) results in large compression and shear forces in the spine, which may increase the risk of musculoskeletal injury, such as a dislocated disc, or the like.

The tool of U.S. Pat. No. 4,978,103 (magnetic dolly) or similar systems requires the application of multiple chains and the complete lifting of the entire weight of the chamber lid above the surface, whereas the present tool slides the chamber lid out of place with the chamber lid maintaining contact with the surface throughout the procedure. In this instance, the full weight of the chamber lid never needs to be supported by the operator. The requirement to lift the full weight of the chamber lid when using the prior art dolly systems results in moment production of over 700N*m at L4/L5 and L5/S1 (see the graph below). In addition, the use of the dolly system requires much more space than the present tool, making it less feasible in urban areas where streets cannot be completely shut down for removal of chamber lids. Dolly systems are also larger and heavier than the present tool when in storage, making transportation on a packed utility van more difficult. Further the dolly systems are not as stable as the present tool in moving a heavy load such as a chamber lid. The wheels make the dolly system extremely unstable in comparison to the present tool. The instability of the dolly system, in particular, when the operator walks with the load, increases the chance of low back injury. The present tool movements however, are completed intermittently and as mentioned earlier the load is slid on the ground by the operator and the fulcrum ski aligns the operator with the load facilitating the optimal operation of the present tool.

### Example 1

### Comparison of Shoulder and Low Back Moments Among Different Chamber Tools

### Example 2

### Comparison of Prior Art and Present Tool

The present tool was compared to the prior art in use with two chamber lids of different mass. One chamber lid (CL) has a mass of 300-320 lbs. A second chamber lid (NL) has a mass of approximately 150 lbs.

The force required to remove each of the two lids with prior art tools and the present tool was recorded with a handheld force meter (Chatillon E-DFE, Ametek, Berwyn, Pa., USA).

13 male utility workers were outfitted with an inertial motion capture system (IGS-180 Animazoo, Synertial, Brighton, UK).

4 conditions were tested (3 trials each):
CL with Pickaxe (PICK)=CL+PICK;
CL with present tool (CLRT)=CL+CLRT;
NL with J-hook (JH)=NL+JH; and
NL with present tool (CLRT)=NL+CLRT.

Kinetic and kinematic data collected were combined in a modelling program (MatLab) which calculates 3D joint moments via inverse dynamics.

Spine L4/L5 and shoulders were selected for analysis. The resultant moment was calculated using the equation RM=\sqrt{(x\hat{-} [symbol] v\hat{-} [symbol] z\hat{-})} where RM=resultant moment; x=x-axis co-ordinate; y=y-axis co-ordinate and z=z-axis co-ordinate, where peak force was applied during the procedure or lid removal. Mean values were compared using a one-way repeated measures ANOVA.

The above chart depicts the force required to remove a chamber lid (CL or NL) with various tools. The Force (N) is significantly lower (p<0.05) with the present tool (CLRT) versus PICK and JH.

The above L4/L5 Resultant Moment Charts 1 and 2 depict that the resultant moment is significantly lower with the present tool when compared to the prior art (PICK and JH).

The Shoulder Resultant Moment Charts 1 and 2 depict that the shoulder resultant moments were significantly (p<0.0001) lower with the present tool (CLRT) when compared to the prior art (PICK and JH).

The L4/L5 Kinematic chart 1 depicts there is significantly more flexion at Sagittal with PICK when compared to all other tools (p<0.05)* and significantly more lateral bend at Frontal with PICK compared to the present tool (CLRT) when removing CL (p=0.048)**.

As many changes can be made to the preferred embodiment of the invention without departing from the scope thereof; it is intended that all matter contained herein be considered illustrative of the invention and not in a limiting sense.

1. A manhole cover tool comprising:
i) A handle end;
ii) a fulcrum end distant said handle end;
iii) a connecting rod of a predetermined length for connecting said handle end to said fulcrum end;
iv) a manhole cover engagement rod of a predetermined length having a first end and a second end; said first end connected to said connecting rod, and said second end being a manhole cover engagement tool;
wherein said handle end, fulcrum end and said first end of said engagement rod form a triangle when connected by a line.

2. The tool of claim 1 wherein at a resting position, said handle end is at a distance from said surface proximate waist height of an operator.

3. The tool of claim 1 wherein said tool further comprises an engagement rod channel for accommodating said engagement rod.

4. The tool of claim 3 wherein said engagement rod channel is substantially arcuate or “D” shape.

5. The tool of claim 4 wherein said engagement rod channel is connected to said connecting rod.

6. The tool of claim 1 wherein said engagement rod is flexible.

7. The tool of claim 1 wherein said manhole cover engagement tool is a hook.

8. The tool of claim 1 comprising of a lightweight and strong material.

9. The tool of claim 8 wherein the material is selected from the group consisting of aluminum, light steel, fiberglass, polypropylene and combinations thereof.

10. The tool of claim 1 wherein said tool is adjustable in length.

11. The tool of claim 1 wherein said engagement rod comprises a plurality of connection points for said first end.

12. The tool of claim 1 wherein said engagement rod is adjustable in length.

13. The use of the tool of claim 1 for maneuvering a manhole cover.

14. A method of maneuvering a manhole cover along a surface while reducing risk of injury to an operator, said method comprising:
i) Positioning the tool of claim 1 proximate a manhole cover;
ii) Connecting the tool of claim 1 to a manhole cover;
iii) Pushing the tool of claim 1 towards said surface;
iv) Pulling said tool of claim 1 away from said manhole cover;
v) Repeating steps iii) and iv) until the manhole cover is at a desired location.

15. The method of claim 14 wherein when the operator is pushing said tool, said operator arms are substantially vertical to the surface and said operator:
i)bends at the waist;
ii) bends at the knees; or
iii) a combination thereof.

16. A system for reducing injury to an operator when maneuvering a manhole cover, said system comprising the tool of claim 1 and the method of claim 14.

17. The tool of claim 1 wherein said tool is substantially triangular in shape.

18. The method of claim 14 in use with the tool of claim 17.

19. A system for reducing injury to an operator when maneuvering a manhole cover, said system comprising the tool of claim 17 and the method of claim 18.

20. The tool of claim 2 wherein said tool is substantially triangular in shape.
